(19) United States
(12) Patent Application Publication
(10) Pub. No.: US 2016/0096771 A1
(43) Pub. Date: Apr. 7, 2016

(54) METHODS OF FORMING A GLASS COMPOSITION

(71) Applicant: Saint-Gobain Ceramics and Plastics, Inc., Worcester, MA (US)

(72) Inventors: Matthieu Schwartz, Courbevoie (FR); Signo Tadeu Reis, Worcester, MA (US); John D. Pietras, Sutton, MA (US)

(21) Appl. No.: 14/864,233

(22) Filed: Sep. 24, 2015

(30) Foreign Application Priority Data
Oct. 1, 2014 (FR) 1402213

(51) Int. Cl. C03C 27/02; C03C 8/24; H01M 8/24; C03B 25/02; H01M 8/02

(52) U.S. Cl. CPC C03C 27/02; C03B 25/02; H01M 8/0286; H01M 8/2485; C03C 8/24

(57) ABSTRACT

A method includes placing a material including a glass precursor material in contact with a second material and annealing the glass precursor material to form a glass composition in contact with the second material. In an embodiment, annealing is performed at a single temperature. In another embodiment, annealing is performed at a temperature in a range of 750° C. to 1000° C. In a particular embodiment, the glass composition includes a crystalline fraction of at least 30%.

### CROSS-REFERENCE TO RELATED APPLICATION

This application claims priority under 35 U.S.C. §119(a) to French Patent Application No. 1402213 entitled “METHODS OF FORMING A GLASS COMPOSITION”, by Schwartz et al., filed Oct. 1, 2014, which is assigned to the current assignee hereof and incorporated herein by reference in its entirety.

### FIELD OF THE DISCLOSURE

This disclosure, in general, relates to methods of forming a glass composition, and, in particular, to forming a glass composition in applications of an electrochemical device.

### BACKGROUND

Glass compositions can be used for seals, bonds, or joints to metallic materials, ceramic materials, or both. The glass composition may have coefficient of thermal expansion (CTE) different from that of one or more components of a device to which the glass composition contacts. As the device cycles between room temperature and the normal operating temperature of the device, for example, from room temperature (approximately 25° C.) to 700° C., 800° C., or higher, the difference in the coefficients of thermal expansion between the glass composition and one or more components it contacts may cause cracks to form and lead to leakage. Leakage in turn can cause inefficient device performance (including device failure), costly device maintenance, and safety related issues. Thus, continued improvement of glass compositions is desired.

### BRIEF DESCRIPTION OF THE DRAWINGS

Embodiments are illustrated by way of example and are not limited in the accompanying figures.

FIG. 1 includes a bar graph of coefficients of thermal expansion for glass compositions made in accordance with embodiments disclosed herein.

FIG. 2 includes micrographs of a portion of a glass composition formed in accordance with an embodiment.

FIG. 3 includes micrographs of a portion a glass composition made in accordance with an embodiment.

FIG. 4 includes micrographs of a portion of another different glass composition formed in accordance with an embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, glass compositions can be described in terms of molecular formulas or as mol percentages of the constituent metal oxides. For example, sanbornite can be expressed as BaSi₂O₅, BaO.2SiO₂, or as 33.3 mol % BaO and 66.7 mol % SiO₂.

The terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the arts related to forming a glass composition in applications of an electrochemical device.

A method of forming the glass composition can include placing a glass precursor material in contact with a metal, a metal alloy, a metallic compound, a ceramic material, or any combination thereof. The glass precursor material can include BaO, SiO₂, and Al₂O₃. The glass precursor material can be annealed to form a glass composition in contact with the metal, metal alloy, a metallic compound, a ceramic material, or any combination thereof. In an embodiment, the anneal can be performed at a single temperature. In a particular embodiment, annealing can be performed at a single temperature in a range of 750° C. to 1000° C. The glass composition can have a crystalline fraction of at least 30 vol %. In another embodiment, the anneal is performed using two portions at different temperatures. Either or both portions may be performed for a time of at least 9 hours.

Particular embodiments as described herein allow for the formation of a high quality seal, bond, or joint by using a relatively low annealing temperature. The ability to form a glass composition at such relatively low annealing temperature can be beneficial to reduce adverse migration of constituent materials between the glass composition and a component which it contacts, material aging and maintaining the electrochemical activity of the component. Furthermore, the glass composition can also have coefficient of thermal expansion (CTE) that can be matched more closely to the component that the glass composition contacts. In an embodiment, the CTE can be in a range of 9.0 ppm/° C. to 13.0 ppm/° C. The glass composition may be used as a seal, a joint, or a bond. Particularly, the high CTE makes the glass composition suitable for applications of sealing, joining, or forming a bond in an electrochemical device. For example, the glass composition can be used as a seal, bond, or joint in applications of a solid oxide fuel cell (SOFC), or a seal, a joint, or a bond between a SOFC stack and a manifold for delivering gas to the stack.

A glass composition can be formed from glass precursor materials. The glass precursor material can include SiO₂, Al₂O₃, and BaO and can be prepared, for example, by melting powder mixtures containing the appropriate amounts, described in details below, of prefired alumina (Al₂O₃), barium carbonate (BaCO₃), and silica (SiO₂). Alternatively, different starting raw materials could be used, such as barium hydroxide, quartz, wet alumina, etc. Melting can be conducted in joule-heated platinum crucibles at a temperature in a range of between 1500° C. and 1600° C. The melts can be allowed to refine for a time period between about one hour and about three hours before being water quenched, resulting in glass frits. The glass frits can be re-solidified (e.g. planetary-ball milled) and screened to produce a glass powder having an average particle size in a range of 0.5 to 10 microns, such as in a range of 0.7 to 4 microns, and having a particle size distribution such that d5 is 5 microns, d50 is 1 micron, and d90 is 0.5 microns. The particle size distribution (PSD) of the resulting powder can be determined using, for example, a Horiba LA920 laser scattering PSD analyzer available from Horiba Instruments, Inc. of Irvine, Calif., USA. The glass powder can be mixed with a polymeric binder and an organic solvent to produce a slurry of glass particles.

In an embodiment, the material including the glass precursor material can include SiO₂ of at least 56 mol %, such as at least 58 mol % or at least 60 mol %. In another embodiment, SiO₂ may be no greater than 69 mol %, such as no greater than 67 mol % or no greater than 65 mol %. In a further embodiment, SiO₂ can be in an amount of 56 mol % to 69 mol %, such as in an amount of 58 mol % to 67 mol % or 60 mol % to 65 mol %. In another embodiment, the amount of BaO present can be at least 28 mol %, such as at least 29 mol % or at least 30 mol %. In yet another embodiment, BaO may be no greater than 36 mol %, such as no greater than 35 mol % or no greater than 34 mol %. In a further embodiment, BaO can be in a range of 28 mol % to 36 mol %, such as in a range of 29 mol % to 35 mol % or in a range of 30 mol % to 34 mol %. As previously described, the barium source may be BaCO₃ instead of BaO. In still another embodiment, the amount of Al₂O₃ can be at least 1 mol %, such as at least 1.5 mol % or at least 2 mol %. In another embodiment, the amount of Al₂O₃ may be no greater than 9.9 mol %, no greater than 9 mol %, or 8 mol %. In a further embodiment, Al₂O₃ can be from 1 mol % to 9.9 mol %, such as 1.5 mol % to 9 mol % and 2 mol % to 8 mol %. One or more of the glass precursor materials may further include a minor oxide, such as Na₂O, K₂O, MgO, CaO, SrO, ZrO₂, TiO₂, or any combination thereof. In an embodiment, the total minor oxide content with all of the glass precursor materials is not greater than 0.5 mol %.

In an embodiment, the constituent oxides of SiO₂, Al₂O₃, and BaO in the glass precursor material can be expressed in a molar ratio between one another. For example, a molar ratio of SiO₂:BaO can be at least 0.6:1, such as at least 0.8:1 or at least 1:1. In another embodiment, the molar ratio of SiO₂:BaO may be no greater than 6:1, such as no greater than 5:1 or no greater than 4:1. In a further embodiment, the molar ratio of SiO₂:BaO in the glass composition can be in a range of 0.6:1 to 8:1, 0.8:1 to 5:1, or 1:1 to 4:1. In another embodiment, a molar ratio of SiO₂:Al₂O₃ can be at least 1:1, such as at least 2:1 or at least 3:1. In yet another embodiment, the molar ratio of SiO₂:Al₂O₃ may be no greater than 9:1, no greater than 8:1, or no greater than 7:1. In a further embodiment, the molar ratio of SiO₂:Al₂O₃ in the glass composition is in a range of 1:1 to 9:1, 2:1 to 8:1, or 3:1 to 7:1.

The glass precursor material can be placed on a component of a device. For example, the component can be a part of an SOFC, such as an electrolyte, an anode, a cathode, an interconnect, or a manifold. The slurry of the glass precursor material formed as described above can be deposited as a thin layer on a surface of a part of the SOFC by various techniques, such as air spraying, plasma spraying, and screen printing. The component can include a metal, a metal alloy, a metallic compound, a ceramic material or a combination thereof. As used herein, a metal is intended to mean metal atoms that are not part of an alloy or a compound. For example, the metal can include nickel, tungsten, titanium, or any combination thereof. The metal alloy can include stainless steel, brass, bronze, TiW, or the like. The ceramic can include an oxide of zirconium, yttrium, strontium, titanium, manganese, lanthanum, chromium, aluminum, calcium, or any combination thereof. For an SOFC, an anode can be a combination of a metal and ceramic, as the anode can include a composite of Ni, NiO, and yttria-stabilized zirconia (YSZ), the cathode can include a lanthanum strontium manganite (LSM), and the electrolyte can include YSZ.

The material including the glass precursor material can be annealed while the glass precursor material is in contact with the material to be sealed, bonded, or joined. In an embodiment, the glass precursor material can be in contact with a single material or a plurality of materials. For example, the glass precursor material may be used to seal an electrode, electrolyte, or interconnect of an SOFC. In another example, the glass precursor material can be in contact with a gas manifold along one side and an SOFC on the opposite side. In a further example, the glass precursor material may be in contact with an oxygen transport membrane.

In an embodiment, annealing can be performed at a temperature of at least 750° C., such as at least 775° C. or at least 800° C. to allow sufficient densification and crystallization of the glass precursor material to occur. In another embodiment, annealing may be performed at a temperature not greater than 1000° C., such as no greater than 975° C. or no greater than 950° C. In a particular embodiment, annealing is performed at a temperature not greater than 900° C. Annealing at a lower temperature may help to decrease or prevent migration of a metal from an interconnect into an adjacent layer of an SOFC, and thus help to maintain electrochemical activity of the materials of the layers of the SOFC. In a further embodiment, annealing can be performed at a temperature between any of the minimal and maximum values disclosed herein. For example, annealing can be performed at a temperature in a range of 750° C. to 1000° C., 775° C. to 975° C., or 800° C. to 950° C. In a particular embodiment, annealing is performed at a temperature in a range of 800 to 900° C.

In another embodiment, annealing can be performed at a desired temperature as described above for a period of time. Depending on other factors such as the composition of the glass precursor material, annealing temperature, desired thickness and crystalline fraction of the glass composition, the period of time for performing annealing can vary. In an embodiment, annealing can be performed for a time of at least 2 hours, such as at least 3 hours or at least 4 hours. In a particular embodiment, a prolonged time for performing annealing may be desired to increase density and crystalline fraction of the glass composition. For example, annealing can be performed for at least 8 hours, 9 hours, or longer. In another embodiment, annealing may be performed for a time of no greater than 24 hours, such as no greater than 16 hours or no greater than 12 hours. In a further embodiment, annealing can be performed for a period of time between any of the minimum and maximum values disclosed herein. For example, annealing can be performed for a time in a range of 2 hours to 24 hours, 3 hours to 16 hours, or 4 hours to 12 hours. In a particular embodiment, annealing can be performed for a time of 6 hours to 10 hours.

In a particular embodiment, annealing can be performed at a single temperature as described above. In yet another embodiment, annealing can be performed at two different temperatures for at least 9 hours at one of the temperatures or for at least 9 hours at each of the temperatures. For example, the first portion of the anneal can be performed at a lower temperature, and the second portion of the anneal can be performed at a higher temperature. The first portion can be used to form a seal, bond, or joint, and the second portion can help to accelerate crystallization to increase the crystallization fraction.

Annealing can be performed at atmospheric pressure. Alternatively, annealing can be performed under vacuum or at a pressure that is higher than atmospheric pressure. Annealing can be performed in air. Alternatively, annealing can be performed in N₂ at a partial pressure different from air, O₂ at a partial pressure different from air, a noble gas at a partial pressure different from air, or any combination thereof. In a further embodiment, annealing can be performed in Ar at a partial pressure different from air.

The CTE of the glass composition can be changed by crystallizing the glass composition. Thus, crystallization during annealing can help the glass composition to match more closely the CTE of the material the glass composition contacts. The annealing can be performed so that the resulting glass composition has a crystalline fraction of at least 30 vol %. For example, the crystalline fraction can be at least 40 vol %, or at least 50 vol % to provide sufficient thermo-mechanical stability to the sealed, bonded, or joined regions as needed or desired for particular applications. In another embodiment, the crystalline fraction may be not greater than 80 vol %, not greater than 70 vol %, or not greater than 60 vol % depending on the material to be sealed, bonded, or joined. In a further embodiment, the crystalline fraction can be between any of the minimal values and maximum values disclosed herein. For example, the crystalline fraction can be in a range of 30 vol % to 80 vol %, 40 vol % to 70 vol %, or 50 vol % to 60 vol %.

The glass composition can include a crystallite having a size of at least 1 micron, such as at least 11 microns, or at least 15 microns. In yet another embodiment, the crystallite may be no greater than 55 microns, no greater than 50 microns, or no greater than 45 microns. The size of the crystallite may vary depending on the composition of the glass precursor material and annealing conditions. In a further embodiment, the crystallite can have a size between any of the minimum values and maximum values disclosed herein. For example, the size can be in a range of 1 micron to 55 microns, 11 microns to 50 microns, or 15 microns to 45 microns.

The glass composition can be in a form of a seal, a bond, a joint, or the like. Thickness of the glass composition can vary depending on its form, for example, a larger thickness may be desired for a bond compared to a seal. Thickness of the glass composition as disclosed herein is measured at room temperature, unless otherwise indicated. In an embodiment, the glass composition can have a thickness of at least 1 micron. For example, the thickness can be at least 5 microns, such as at least 20 microns, at least 30 microns, or at least 50 microns. In another embodiment, the glass composition may have a thickness of no greater than 10000 microns. For example, the thickness may be not greater than 5000 microns, such as no greater than 2000 microns, no greater than 900 microns, no greater than 700 microns, or no greater than 500 microns, as desired by the applications of the glass composition. In a further embodiment, the glass composition can have a thickness between any of the minimum and maximum values disclosed herein. For example, the thickness can be in a range of 1 micron to 10000 microns, such as 5 microns to 5000 microns, 20 microns to 900 microns, 30 microns to 700 microns, or 50 microns to 500 microns.

In a further embodiment, as desired in a particular application of the glass composition, the thickness of the glass composition can be controlled to build up by using coat-dry-coat-dry-firing or coat-dry-firing-coat-dry-firing approaches repetitively. A glass slurry coat can be dried and successive coats can be deposited on the dried glass powder repetitively to achieve a desired thickness. For each successive coat, it may be desired to dry the previous coat before applying another coat, and then the multi-coat can be fired together in a single heat treatment. Alternatively, additional layers of the glass compositions can be deposited on top of an already fired layer, and the process can be repeated multiple times to achieve a desired thickness.

CTEs as described herein are the CTEs as measured from 25° C. to 700° C. In conjunction with the annealing conditions disclosed above, the CTE can be at least 9.0 ppm/° C., such as at least 10.3 ppm/° C. or at least 10.6 ppm/° C. In another embodiment, the glass composition may have a CTE of no greater than 13.0 ppm/° C., such as no greater than 12.7 ppm/° C., or no greater than 12.5 ppm/° C. In yet another embodiment, the glass composition can have a CTE in a range of 9.0 ppm/° C. to 13.0 ppm/° C., 10.3 ppm/° C. to 12.7 ppm/° C., or 10.6 ppm/° C. to 12.5 ppm/° C. Depending on the applications of the glass composition, the CTE of the glass composition can match closely to that of the material to be sealed, bonded, or joined. For example, the glass composition having a CTE in a range of 11.0 ppm/° C. to 12.5 ppm/° C. is well suited for use with an SOFC. In another embodiment, the glass composition having a CTE of 10.6 ppm/° C. to 12.5 ppm/° C. can be suitable for use with oxygen transport membranes (OTMs).

Embodiments as described herein allow for a glass composition to be formed at a relatively lower temperature and still obtain a desired CTE. The flexibility in the amounts of BaO, Al₂O₃, and SiO₂ can allow the glass composition to be tailored for a particular application. The relatively low annealing temperature allows the sealing, bonding, or joining using the glass composition with a lower risk of adverse material interaction.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.
Embodiment 1. A method comprising:
   placing a first material in contact with a second material, wherein the first material comprises a glass precursor material including SiO₂, Al₂O₃, and BaO, and the second material comprises a metal, a metal alloy, a metallic compound, a ceramic material, or any combination thereof; and
   annealing the first material to form a glass composition in contact with the second material, wherein annealing is performed at a single temperature, and the glass composition has a crystalline fraction of at least 30 vol %.
Embodiment 2. A method comprising:
   placing a first material in contact with a second material, wherein the first material comprises a glass precursor material including SiO₂, Al₂O₃, and BaO, and the second material comprises a metal, a metal alloy, a metallic compound, a ceramic material, or any combination thereof; and
   annealing the glass precursor material to form a glass composition in contact with the second material, wherein annealing is performed at a single temperature in a range of 750° C. to 1000° C.
Embodiment 3. The method of any one of the preceding Embodiments, wherein annealing is performed at the temperature of at least 750° C., at least 775° C., or at least 800° C.
Embodiment 4. The method of any one of the preceding Embodiments, wherein annealing is performed at the temperature of no greater than 1000° C., no greater than 975° C., or no greater than 950° C.
Embodiment 5. The method of any one of the preceding Embodiments, wherein annealing is performed at the temperature in a range of 750° C. to 1000° C., 775° C. to 975° C., or 800° C. to 950° C.
Embodiment 6. The method of any one of the preceding Embodiments, wherein annealing is performed for a time of at least 2 hours, at least 3 hours, or at least 4 hours.
Embodiment 7. The method of any one of the preceding Embodiments, wherein annealing is performed for a time of no greater than 24 hours, no greater than 16 hours, or no greater than 12 hours.
Embodiment 8. The method of any one of the preceding Embodiments, wherein annealing is performed for a time in a range of 2 hours to 24 hours, 3 hours to 16 hours, or 4 hours to 12 hours.
Embodiment 9. A method comprising:
   placing a first material in contact with a second material, wherein the first material comprises a glass precursor including SiO₂, Al₂O₃, and BaO, and the second material comprises a metal, a metal alloy, a metallic compound, a ceramic material, or any combination thereof; and
   annealing the first material to form a glass composition in contact with the second material, wherein annealing includes:
   a first portion is performed at a first temperature for a first time; and
   a second portion is performed at a second temperature for a second time, wherein:
      the first temperature is different from the second temperature; and
      the first time, the second time, or each of the first and second times is at least 9 hours.
Embodiment 10. The method of Embodiment 9, wherein the first portion, the second portion, or each of the first and second portions is performed at the temperature of at least 750° C., at least 775° C., or at least 800° C.
Embodiment 11. The method of Embodiment 9 or 10, wherein the first portion, the second portion, or each of the first and second portions is performed at the temperature of no greater than 1000° C., no greater than 975° C., or no greater than 950° C.
Embodiment 12. The method of any one of Embodiments 9 to 11, wherein the first portion, the second portion, or each of the first and second portions is performed at the temperature in a range of 750° C. to 1000° C., 775° C. to 975° C., or 800° C. to 950° C.
Embodiment 13. The method of any one of Embodiments 9 to 12, wherein annealing is performed for a time of no greater than 24 hours, no greater than 16 hours, or no greater than 12 hours.
Embodiment 14. The method of any one of the preceding Embodiments, wherein annealing is performed under vacuum.
Embodiment 15. The method of any one of Embodiments 1 to 13, wherein annealing is performed at atmospheric pressure.
Embodiment 16. The method of any one of Embodiments 1 to 13, wherein annealing is performed at a pressure in a higher than atmospheric pressure.
Embodiment 17. The method of any one of the preceding Embodiments, wherein annealing is performed in air.
Embodiment 18. The method of any one of Embodiments 1 to 16, wherein annealing is performed in N₂ at a partial pressure different from air, 0₂ at a partial pressure different from air, a noble gas at a partial pressure different from air, or any combination thereof.
Embodiment 19. The method of any one of Embodiments 1 to 16 and 18 wherein annealing is performed in Ar at a partial pressure different from air.
Embodiment 20. The method of any one of the preceding Embodiments, wherein the glass composition has a coefficient of thermal expansion from 25° C. to 700° C. of at least 9.0 ppm/° C., at least 10.3 ppm/° C., or at least 10.6 ppm/° C.
Embodiment 21. The method of any one of the preceding Embodiments, wherein the glass composition has a coefficient of thermal expansion from 25° C. to 700° C. of no greater than 13.0 ppm/° C., no greater than 12.7 ppm/° C., or no greater than 12.5 ppm/° C.
Embodiment 22. The method of any one of the preceding Embodiments, wherein the glass composition has a coefficient of thermal expansion from 25° C. to 700° C. in a range of 9.0 ppm/° C. to 13.0 ppm/° C., 10.3 ppm/° C. to 12.7 ppm/° C., or 10.6 ppm/° C. to 12.5 ppm/° C.
Embodiment 23. The method of any one of the preceding Embodiments, wherein the glass composition has a crystalline fraction of at least 30 vol %, at least 40 vol %, or at least 50 vol %.
Embodiment 24. The method of any one of the preceding Embodiments, wherein the glass composition has a crystalline fraction no greater than80 vol %, greater than 70 vol %, or greater than 60 vol %.
Embodiment 25. The method of any one of the preceding Embodiments, wherein the glass composition has a crystalline fraction in a range of 30 vol % to 80 vol %, 40 vol % to 70 vol %, or 50 vol % to 60vol %.
Embodiment 26. The method of any one of the preceding Embodiments, wherein the glass composition has crystallites having a size of at least 1 micron, at least 11 microns, or at least 15 microns.
Embodiment 27. The method of any one of the preceding Embodiments, wherein the glass composition has crystallites having a size no greater than 55 microns, no greater than 50 microns, or no greater than 45 microns.
Embodiment 28. The method of any one of the preceding Embodiments, wherein the glass composition has crystallites having a size in a range of 1 micron to 55 microns, 11 microns to 50 microns, or 15 microns to 45 microns.
Embodiment 29. The method of any one of the preceding Embodiments, wherein the glass composition is in a part of a seal, a bond, or a joint.
Embodiment 30. The method of any one of the preceding Embodiments, wherein the glass composition has a thickness in a range of at least 1 micron, at least 5 microns, at least 20 microns, at least 30 microns, or at least 50 microns.
Embodiment 31. The method of any one of the preceding Embodiments, wherein the glass composition has a thickness of no greater than 10,000 microns, not greater than 5000 microns, not greater than 900 microns, no greater than 700 microns, or no greater than 500 microns.
Embodiment 32. The method of any one of the preceding Embodiments, wherein the glass composition has a thickness in a range of 1 micron to 10000 microns, 5 microns to 5000 microns, 20 microns to 900 microns, 30 microns to 700 microns, and 50 microns to 500 microns.
Embodiment 33. The method of any one of the preceding Embodiments, wherein a molar ratio of SiO₂:BaO in the glass composition is at least 0.6:1, at least 0.8:1, or at least 1:1.
Embodiment 34. The method of any one of the preceding Embodiments, wherein a molar ratio of SiO₂:BaO in the glass composition is no greater than 6:1, no greater than 5:1, or no greater than 4:1.
Embodiment 35. The method of any one of the preceding Embodiments, wherein a molar ratio of SiO₂:BaO in the glass composition is in a range of 0.6:1 and 8:1, 0.8:1 to 5:1, or 1:1 and 4:1.
Embodiment 36. The method of any one of the preceding Embodiments, wherein a molar ratio of SiO₂:Al₂O₃ in the glass composition is at least 1:1, at least 2:1, or at least 3:1.
Embodiment 37. The method of any one of the preceding Embodiments, wherein a molar ratio of SiO₂:Al₂O₃ in the glass composition is no greater than 9:1, no greater than 8:1, or no greater than 7:1.
Embodiment 38. The method of any one of the preceding Embodiments, wherein a molar ratio of SiO₂:Al₂O₃ in the glass composition is in a range of 1:1 and 9:1, 2:1 to 8:1, or 3:1 and 7:1.
Embodiment 39. The method of any one of the preceding Embodiments, wherein the glass composition has an Al₂O₃ content in a range of 1 mol % to 9.9 mol %, 1.5 mol % to 9 mol %, or 2 mol % to 8 mol %.
Embodiment 40. The method of any one of the preceding Embodiments, wherein glass composition has an Al₂O₃ content of at least 1 mol %, at least 1.5 mol %, or at least 2 mol %.
Embodiment 41. The method of any one of the preceding Embodiments, wherein glass composition has an Al₂O₃ content no greater than 9.9 mol %, at least 9 mol %, or at least 8 mol %.
Embodiment 42. The method of any one of the preceding Embodiments, wherein glass composition has an Al₂O₃ content in a range of 1 mol % to 9.9 mol %, 1.5 mol % to 9 mol %, or 2 mol % to 8 mol %.
Embodiment 43. The method of any one of the preceding Embodiments, wherein glass composition has an SiO₂ content of at least 56 mol %, at least 58 mol %, or at least 60 mol %.
Embodiment 44. The method of any one of the preceding Embodiments, wherein glass composition has an SiO₂ content no greater than 69 mol %, at least 67 mol %, or at least 65 mol %.
Embodiment 45. The method of any one of the preceding Embodiments, wherein glass composition has an SiO₂ content in a range of 56 mol % to 69 mol %, 58 mol % to 67 mol %, or 60 mol % to 65 mol %.
Embodiment 46. The method of any one of the preceding Embodiments, wherein glass composition has a BaO content of at least 28 mol %, at least 29 mol %, or at least 30 mol %.
Embodiment 47. The method of any one of the preceding Embodiments, wherein glass composition has a BaO content no greater than 36 mol %, at least 35 mol %, or at least 34 mol %.
Embodiment 48. The method of any one of the preceding Embodiments, wherein glass composition has a BaO content in a range of 28 mol % to 36 mol %, 29 mol % to 35 mol %, or 30 mol % to 34 mol %.
Embodiment 49. The method of any one of the preceding Embodiments, wherein the glass composition comprises a minor oxide including Na₂O, K₂O, MgO, CaO, SrO, ZrO₂, TiO₂, or any combination thereof.
Embodiment 50. The method of Embodiment 49, wherein the minor oxide is in an amount of not greater than 0.5 mol %.
Embodiment 51. The method of any one of the preceding Embodiments, wherein the second material is a metal, a metal alloy, or a metallic compound.
Embodiment 52. The method of Embodiment 51, wherein the metal includes nickel, titanium, tungsten, or any combination thereof.
Embodiment 53. The method of any one of the preceding Embodiments, wherein the second material is a ceramic.
Embodiment 54. The method of Embodiment 53, wherein the ceramic includes an oxide of zirconium, yttrium, strontium, titanium, manganese, lanthanum, chromium, aluminum, calcium, or any combination thereof.
Embodiment 55. The method of any one of the preceding Embodiments, wherein the second material is part of an electrode of a fuel cell.
Embodiment 56. The method of any one of the preceding Embodiments, wherein the second material is part of an electrolyte of a fuel cell.
Embodiment 57. The method of any one of the preceding Embodiments, wherein the second material is part of a manifold for a fuel cell.
Embodiment 58. The method of any one of the preceding Embodiments, wherein the second material is part of an interconnect for a fuel cell.
Embodiment 59. The method of any one of the preceding Embodiments, wherein the second material is part of an oxygen transport membrane.
Embodiment 60. An article comprising the material and the glass composition formed by the method of any one of the preceding Embodiments.

### EXAMPLES

The examples formed in accordance with embodiments as described above are presented to demonstrate that relatively low temperature anneals can be used to form glass compositions with acceptable CTEs and good crystallization fractions. The examples are intended to illustrate and not limit the scope of the appended claims.

Samples were prepared with compositions as presented in Table 1 below.

TABLE 1

| Sample | SiO₂ (mol %) | Al₂O₃ (mol %) | BaO (mol %) |
|---|---|---|---|
| A | 64.31 | 3.53 | 32.16 |
| B | 63.10 | 5.35 | 31.54 |
| C | 62.32 | 6.52 | 31.16 |
| D | 61.54 | 7.70 | 30.77 |

A portion of each of Samples A to D was annealed at 850° C. for 8 hours, another portion of each of Samples A to D was annealed at 900° C. for 8 hours and a further portion of each of Samples A to D was annealed at 850° C. for 12 hours followed by an anneal at 900° C. for 12 hours. All anneals were preformed at atmospheric pressure in air.

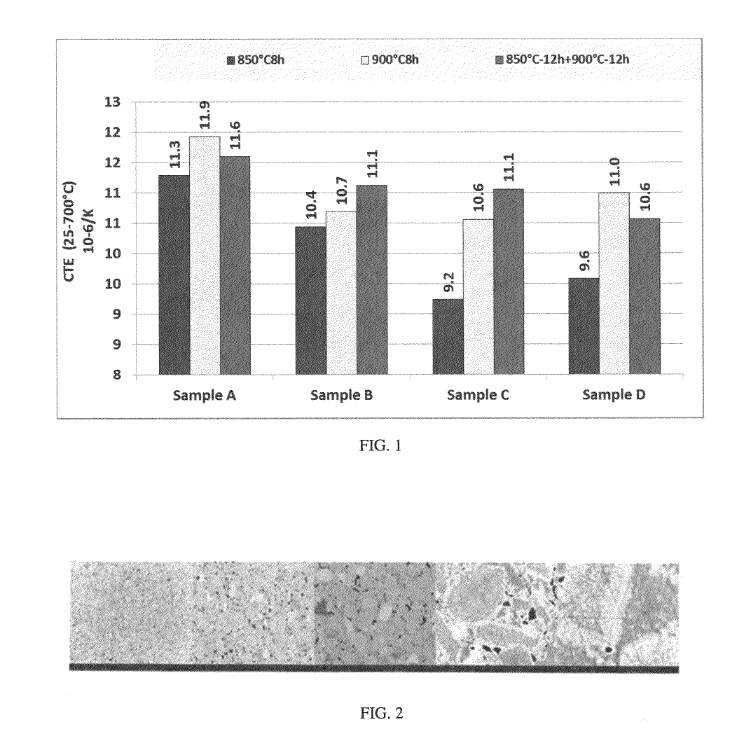

CTEs were measured over a temperature range from 25° C. to 700° C. FIG. 1 includes a bar graph with the data. For the same annealing conditions, CTE decreases as Al₂O₃ content increases. Samples A to D are well suited for use in an SOFC, and of such samples, Sample A has CTEs that are more closely matched to the materials in an SOFC. The Samples B to D may be used for some of the annealing conditions. Material interactions may be more significant as the temperature and time increases. Thus, Sample A when annealed at 850° C. for 8 hours has a good combination of CTE for an SOFC and lower likelihood of adverse material interaction due to its relatively low temperature and time, as compared to the other annealing conditions. The other samples may be well suited for other particular applications. For example, the electrolyte layer of an SOFC may have a CTE of 10.5 ppm/° C., and Sample B may be better suited for use with the electrolyte layer.

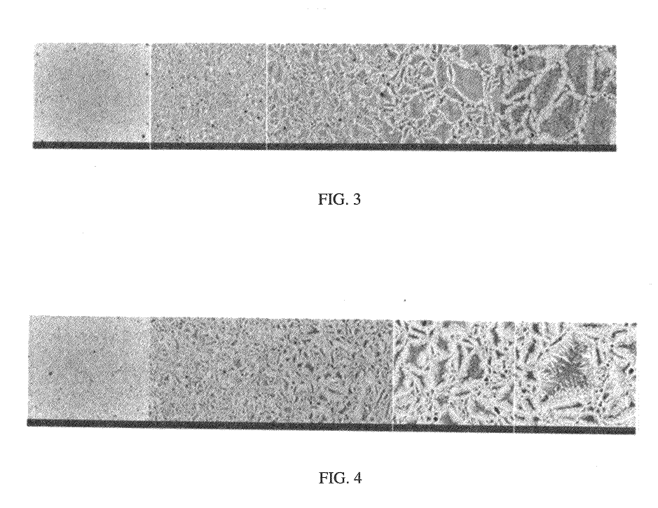

FIGS. 2 to 4 include micrographs of Samples B to D, respectively, among which microstructures of Samples B to D are demonstrated. Each of these samples was annealed at 900° C. for 8 hours. Crystallization can be seen in these samples with visible differences among the samples.

The methods disclosed herein take advantages of low temperature annealing to reduce adverse material interaction and metal diffusion, which often takes place in metallic material of an electrochemical device at temperature higher than 900° C. The glass composition formed in accordance with the methods in general demonstrates proper crystallization and good sinterability. Further, the glass composition having advantageous CTE, can be applied to an electrochemical device or a variety of ionic transport devices in which a seal is required between high-CTE materials, such as oxygen transport membranes, H₂ transport membranes, ceramic membrane reactors, or for use with high-temperature electrolysis. The glass composition and methods disclosed herein can be expected to provide a robust, hermetic seal, joint, or bond as desired in these applications and contribute to a longer device lifetime by minimizing the thermal stress due to CTE mismatch between sealant and the devices

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A method comprising:
placing a first material in contact with a second material, wherein the first material comprises a glass precursor material including SiO₂, Al₂O₃, and BaO, and the second material comprises a metal, a metal alloy, a metallic compound, a ceramic material, or any combination thereof; and
annealing the first material to form a glass composition in contact with the second material, wherein annealing is performed at a single temperature, and the glass composition has a crystalline fraction of at least 30 vol %.

2. The method of claim 1, wherein annealing is performed at the temperature in a range of 750° C. to 1000° C.

3. The method of claim 1, wherein the glass composition has a coefficient of thermal expansion from 25° C. to 700° C. in a range of 9.0 ppm/° C. to 13.0 ppm/° C.

4. The method of claim 1, wherein the glass composition comprises an Al₂O₃ content in a range of 1 mol % to 9.9 mol %.

5. The method of claim 1, wherein glass composition has a SiO₂ content in a range of 56 mol % to 69 mol %.

6. The method of claim 1, wherein glass composition has a BaO content in a range of 28 mol % to 36 mol %.

7. A method comprising:
placing a first material in contact with a second material, wherein the first material comprises a glass precursor material including SiO₂, Al₂O₃, and BaO, and the second material comprises a metal, a metal alloy, a metallic compound, a ceramic material, or any combination thereof; and
annealing the glass precursor material to form a glass composition in contact with the second material, wherein annealing is performed at a single temperature in a range of 750° C. to 1000° C.

8. The method of claim 7, wherein the glass composition has a coefficient of thermal expansion from 25° C. to 700° C. in a range of 9.0 ppm/° C. to 13.0 ppm/° C.

9. The method of claim 7, wherein the glass composition has a crystalline fraction in a range of 30 vol % to 80 vol %

10. The method of claim 7, wherein a molar ratio of SiO₂:BaO in the glass composition is in a range of 0.6:1 and 8:1.

11. The method of claim 7, wherein a molar ratio of SiO₂:Al₂O₃ in the glass composition is in a range of 1:1 and 9:1

12. The method of claim 7, wherein the second material includes a metal, a metal alloy, or a metallic compound.

13. The method of claim 7, wherein the second material includes a ceramic.

14. A method comprising:
placing a first material in contact with a second material, wherein the first material comprises a glass precursor including SiO₂, Al₂O₃, and BaO, and the second material comprises a metal, a metal alloy, a metallic compound, a ceramic material, or any combination thereof; and
annealing the first material to form a glass composition in contact with the second material, wherein annealing includes:
a first portion is performed at a first temperature for a first time; and
a second portion is performed at a second temperature for a second time,
wherein:
the first temperature is different from the second temperature; and
the first time, the second time, or each of the first and second times is at least 9 hours.

15. The method of claim 14, wherein the first portion, the second portion, or each of the first and second portions is performed at the temperature in a range of 750° C. to 1000° C.

16. The method of claim 14, wherein the glass composition has a coefficient of thermal expansion from 25° C. to 700° C. in a range of 9.0 ppm/° C. to 13.0 ppm/° C.

17. The method of claim 14, wherein the glass composition has a crystalline fraction in a range of 30 vol % to 80 vol %.

18. The method of claim 14, wherein the glass composition is in a part of a seal, a bond, or a joint.

19. The method of claim 14, wherein the glass composition comprises an Al₂O₃ content in a range of 1 mol % to 9.9 mol %, an SiO₂ content in a range of 56 mol % to 69 mol %, and a BaO content in a range of 28 mol % to 36 mol %, 29 mol % to 35 mol %, or 30 mol % to 34 mol %.

20. The method of claim 14, wherein the glass composition comprises a minor oxide including Na₂O, K₂O, MgO, CaO, SrO, ZrO₂, TiO₂, or any combination thereof.
